(19) United States
(12) Patent Application Publication
(10) Pub. No.: US 2005/0072302 A1
(43) Pub. Date: Apr. 7, 2005

(54) Screen filter assembly and engines using same

(76) Inventors: Terry L. Miller, Morton, IL (US); C. Brian Myer, Peoria, IL (US)

Correspondence Address: Michael B. McNeil;Liell & McNeil Attorneys PC, P.O. Box 2417, Bloomington, IN, 47402, US

(21) Appl. No.: 10/679,175

(22) Filed: Oct. 3, 2003

(51) Int. Cl. B01D 46/00

(52) U.S. Cl. 95/273; 55/385.3; 55/502; 55/498; 55/482; 55/525

(57) ABSTRACT

An engine is equipped with a filter assembly with a structure that prevents assembly without a filter element in place. In addition, one can choose between a cleanable metallic screen filter element or a replaceable conventional pleated paper filter element. Depending upon the circumstances, the engine user can switch between the two different filter types throughout the working life of the engine.

### TECHNICAL FIELD

The present invention relates generally to screen filter assemblies, and more particularly to a cleanable filter assembly for an engine that may be substituted in place of a conventional paper filter element.

### BACKGROUND

Filter assemblies for filtering liquids such as engine oil, hydraulic oil and fuel are well known in the art. A fuel filter assembly is installed in the engine fuel lines to remove grit and other contaminants from the fuel or other fluids to increase the service life of the fluid system and associated components. Disposable or “throw-away” type of fluid filters, such as those including paper filter elements, are also known in the art. For instance, co-owned U.S. Patent Application Publication No. U.S. 2003/0019809 shows a fuel filter assembly that includes a disposable paper filter element. Depending on the application, the paper filter element should be replaced on some predetermined frequency, such as every so many hundreds of hours of engine operation. Problems can sometimes arise in instances where the filter is actually in need of replacement before the prescribed time period due to excessive filtering of unexpectedly dirty fuel. In addition, problems can sometimes arise in instances where a replacement filter element may not be readily available.

Another reoccurring problem that sometimes occurs with prior art filter assemblies is when a filter assembly is reattached to an engine with the filter element mistakenly omitted. In other words, the owner of the vehicle and/or the maintenance technician may dispose of a used filter element, but unknowingly fail to replace the filter element, or replace the filter element with a substandard will-fit filter. Thus, in some prior art fuel filter assemblies, a threaded reusable housing attaches to a filter head, but it is possible to attach the housing to the head without the correct replacement filter installed, or reattach without any filter installed. Those skilled in the art will appreciate that operation of a fluid system without a filter in place, or without the correct filter element, can jeopardize the integrity of the filtering system, possibly resulting in serious consequences, such as engine damage and/or fuel injector clogging.

The present invention is directed to overcoming one or more of the problems identified above.

### SUMMARY OF THE INVENTION

In one aspect, a filter assembly includes a center support having a filter head attachment adjacent one end, a bowl attachment adjacent an opposite end, and a plurality of radial openings located between the ends. A metallic screen filter element is mounted around the center support.

In another aspect, a method of servicing a filtration portion of a fluid system for an engine includes a step of detaching a center support from a filter head and a bowl. If a paper filter element is mounted on the center support, then a new filter element is substituted for the paper filter element. If a metallic screen filter element is mounted on the center support, then the metallic screen filter element is washed. The center support is then reattached to the bowl, and to the filter head.

### BRIEF DESCRIPTION OF THE DRAWINGS

FIG. 1 is a schematic view of a pair of engines, one having a metallic screen filter element and the other having a paper filter element;

FIG. 2 is a perspective view of a bowl and center support for a filter assembly according to the present invention;

FIG. 3 is an enlarged partial sectioned perspective view of one end of a screen filter element assembly according to one aspect of the present invention;

FIG. 4 is an enlarged sectioned partial perspective view of a screen filter element assembly according to another aspect of the present invention;

FIG. 5 is an enlarged sectioned partial perspective view of a filter element assembly according to still another aspect of the present invention; and

FIG. 6 in an enlarged sectioned partial perspective view of a screen filter element assembly according to still another aspect of the present invention.

### DETAILED DESCRIPTION

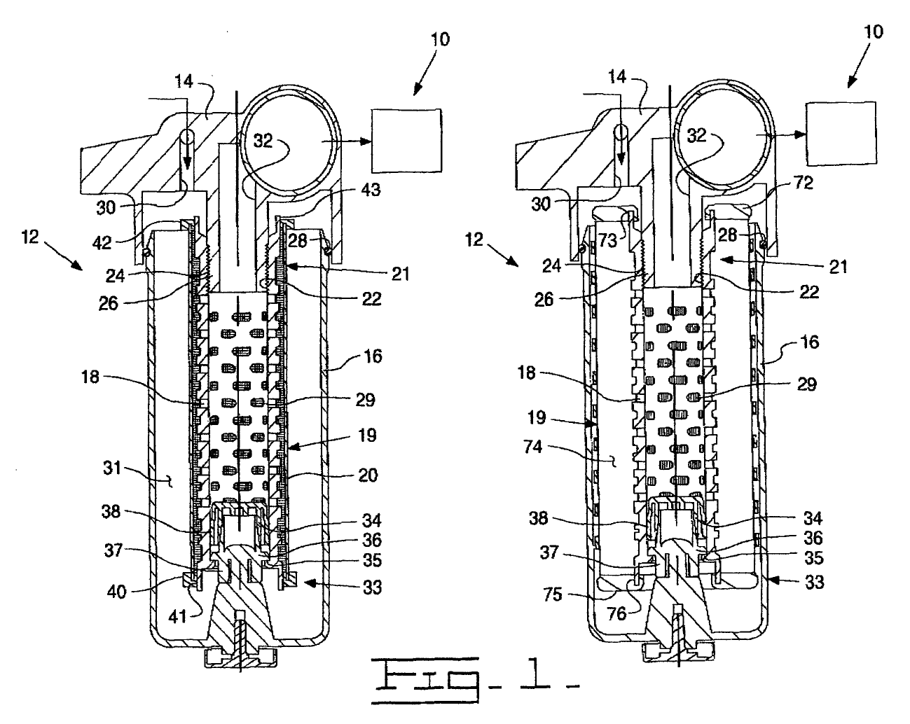

Referring to FIG. 1, a pair of engines 10 each include a fuel filter assembly 12. The engines are identical except that the filter assembly 12 on the left includes a screen filter element 20, whereas the engine on the right has a paper filter element 74. The present invention allows for an engine buyer or/and user to choose between a washable screen filter element 20 or a replaceable paper filter element 74. Preferably, the filter assembly of the present invention is a pre-filter for removing relatively large particulate matter. In other words, an engine according to the present invention would likely include a pre-filter according to the present invention, and later down stream include a fine filter for removing small particles so that only finely filtered fuel is injected into the engine. When in operation, fuel enters filter assembly 12 at an inlet 30, passes through the filter element 20, 74 and then exits the filter assembly at an outlet 32 for later supply to a combustion portion of engine 10 in a conventional manner.

Each filter assembly 12 includes a filter head 14, a bowl 16, a center support 18 and a filter element 19, which can either be a screen 20 or a pleated paper filter element 74. Center support 18 is shown as a center tube which is preferably nonmetallic and formed from rigid polymer material to include a plurality of radial openings 29. Center tube 18 includes a head attachment end 21 that includes features to facilitate attachment to filter head 14. In this illustrated embodiment, head attachment end 21 includes internal threads 22 that mate to external threads 24 on a threaded stud portion of filter head 14. Those skilled in the art will recognize that any suitable attachment structure could be substituted for the threaded attachment. Center tube 18 also includes a bowl attachment end 33 with a female locking mechanism 38 that mates to a male locking member 36 that is attached to, and positioned inside of, bowl 16. Although center support 18 is shown as a tube, those skilled in the art will appreciate that any center support having a filter head attachment located at one end and a bowl attachment located at an opposite end could fall within the intended scope of the present invention. For instance, the two attachment ends could simply be separated by a plurality of posts or the like. Although not preferred, the opposite attachment ends could be supported by the filter element itself. In any event, by utilizing the illustrated structure, the bowl 16 cannot be mated to the filter head 14 without center support 18 being present. Preferably, the filter element 19 is permanently affixed to the center support in some suitable manner. This aspect of the invention prevents the filter head assembly 12 from being inadvertently reassembled without a filter element in place. Nevertheless, the invention also contemplates a structure in which the center support can be disconnected from the filter element.

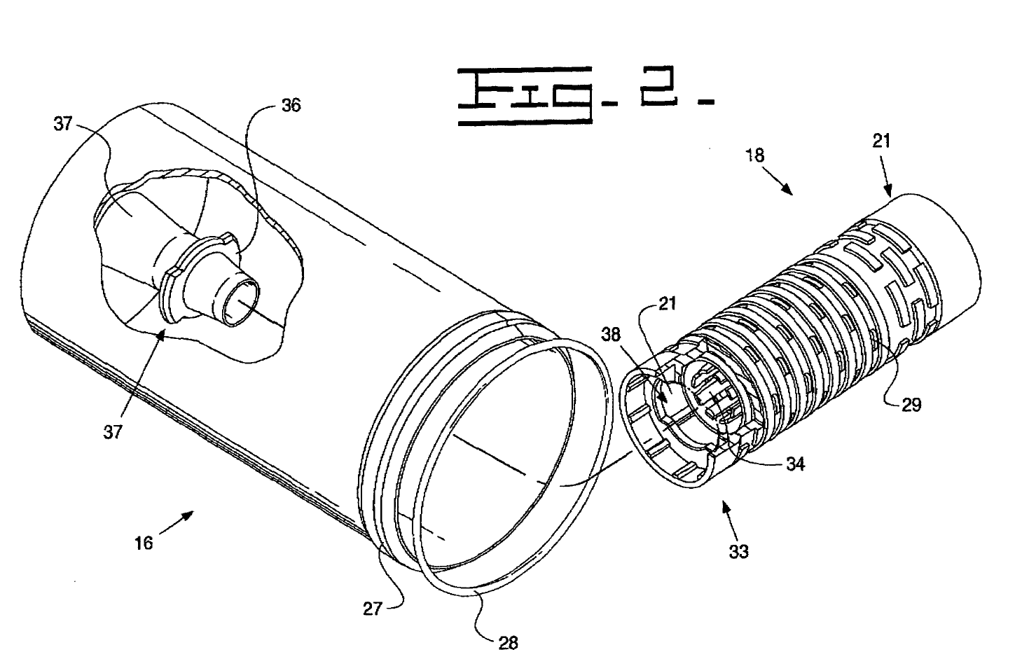

Referring in addition to FIG. 2, the male/female locking structure that allows the center support 18 to be attached to the bowl 16 is illustrated disconnected from one another. Bowl 16 is preferably constructed from a rigid polymer material that can be clear or opaque, depending upon the filter application. The open end of bowl 16 has an annular sealing groove 27 that receives an O-Ring seal 28. The opposite end may include a valve to facilitate evacuation of water trapped in the filter assembly 12. As seen in FIGS. 1 and 2, the O-Ring 28 prevents leakage between filter head 14 and bowl 16. By preferably utilizing a nonmetallic center tube or support 18 along with a nonmetallic bowl 16, one potential source of undesirable metal particles or other contaminants may be prevented from entering the fluid system. Bowl 16 is preferably molded to include a male stem 37 that includes a male locking member 36. Male locking member 36 is preferably keyed to be received in a similar shaped opening toward the bowl attachment end 33 of center support 18. Center support 18 is attached to bowl 16 by mating the male locking member 36 with the female locking mechanism 38 until the male stem 37 engages tangs 34. After being rotated through an angle of 90 degrees, ledges 35 prevent separation of the center support 18 from bowl 16. Preferably, a stop surface formed adjacent tangs 34 prevent the bowl from being rotated beyond the 90 degree rotation lock position. The bowl is locked axially in place until the ledges 35 are rotated back into alignment with the keyed opening of the female locking mechanism 38.

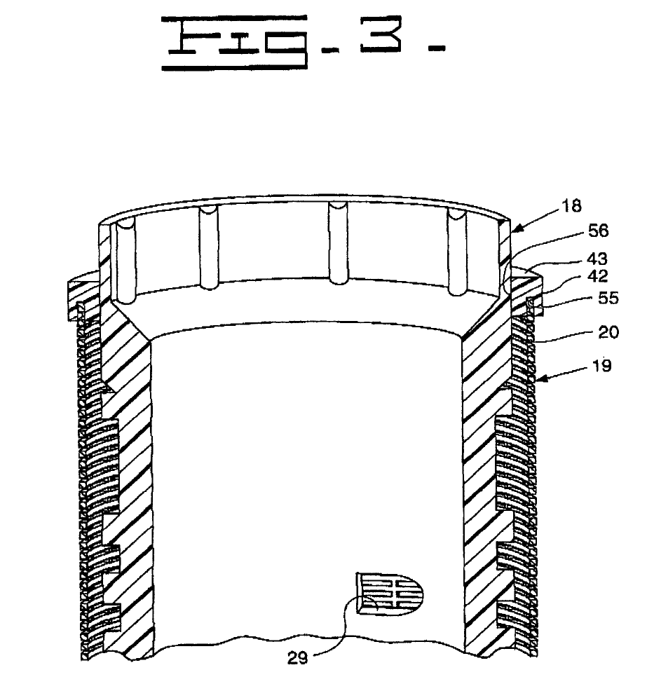

In the prior art filter assembly 12 shown in the right side of FIG. 1, the filter element assembly 19 includes a conventional paper filter element 74 attached between end caps 72 and 75. End caps 72 and 75 are also attached via grooves 73 and 76 to center support 18 in a conventional manner, such as via adhesives, sonic welding, overmolding techniques or any other suitable manner known in the art. The filter element assembly 12 shown in the left hand side of FIG. 1 includes a filter element assembly 19 that includes a metallic screen mesh tube 20 that is mounted between end caps 40 and 42. As best shown in FIG. 3, end caps 40 and 42 are preferably plastic and are overmolded to include an annular groove 55 that receives the annular edge of metallic screen 20. The end cap 42 can be attached to center support 18 in any suitable manner, such as by sonically welding an inner surface 56 of the end cap to an outer surface or end of center support 18. Likewise, the end cap 40 can be attached to the opposite end 41 of center support 18 in a like manner. In the preferred embodiment, screen 20 is a metallic mesh that can be coated with a suitable hydrophobic coating, such as Teflon, to assist in separating water from fuel, if the filter assembly is being used as a fuel filter as in the illustrated embodiments. In a preferred embodiment, the screen mesh would be at least a 40 micron mesh, which would be suitable for use as a pre-filter in a fuel system for a diesel engine. In the preferred versions of the invention, the filter element assembly 19 is irreversibly attached to the center support 18.

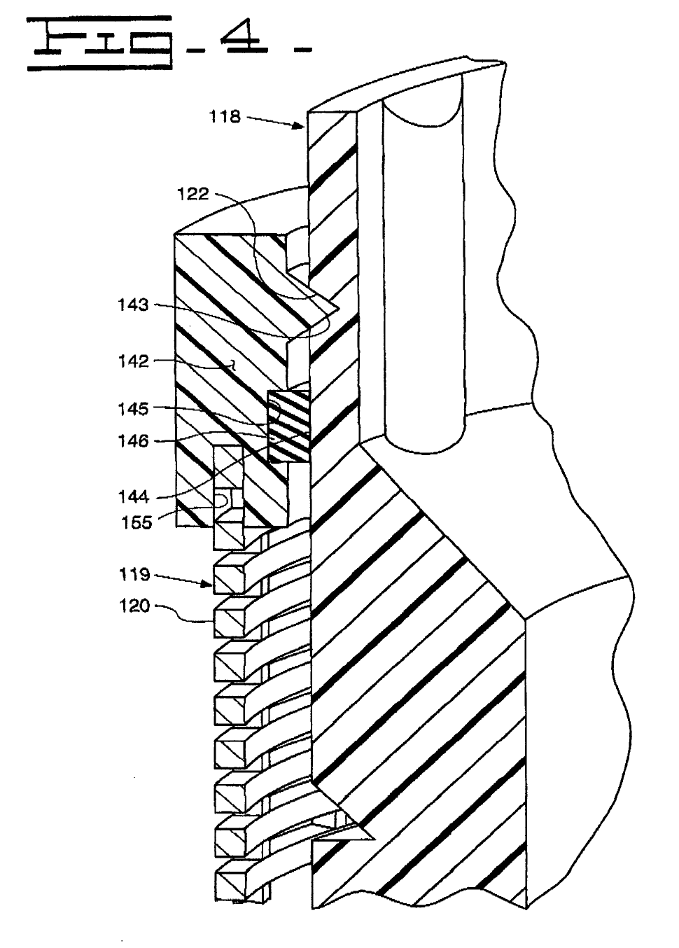

Referring to FIG. 4, an alternative embodiment of the present invention includes a snap attachment of the filter element assembly 119 to the center support 118. In particular, an end cap 142 is overmolded around screen 120 to include an annular groove 155 that receives the annular end of screen 120. In addition, the end cap 142 includes an annular groove 145 that receives an annular seal 146 that sealingly engages the outer surface 143 of center support 118. Finally, end cap 142 is molded to include an annular protrusion 143 that snaps into an annular indentation 122 formed on the outer surface of center support 118. Annular groove 142 preferably has a locking action that preferably inhibits later disengagement of the filter element 119 from the center support 118. Those skilled in the art will appreciate that the structure of FIG. 4 could be blended with the structure of FIG. 3 such that the assembly process initially slides the filter element assembly 119 onto a center support 118 until the annular protrusion 143 comes in locking engagement with annular groove 122. Thereafter, the other end cap, which could have a structure of the type shown in FIG. 3 is sonically welded to the center support to both complete the attachment and to seal against leakage between the inner surface of the end cap and the outer surface of the center support.

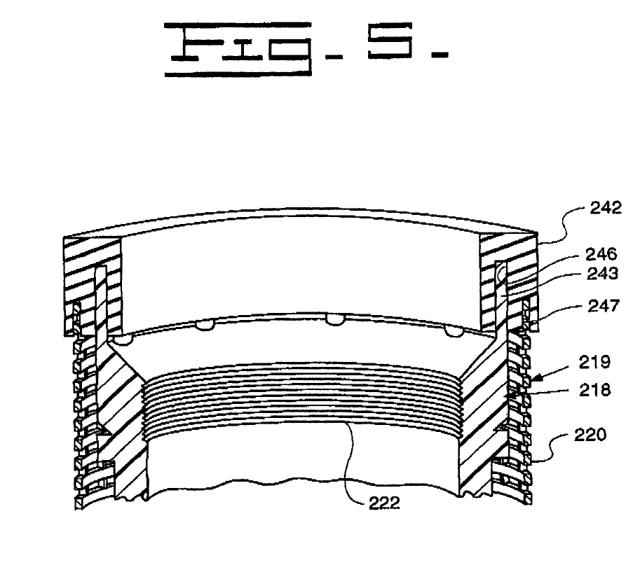

Referring now to FIG. 5, still another attachment strategy is illustrated. In this embodiment, a rubber end cap 242 is over molded to include a groove 246 that receives an annular end 243 of center support 218, and a second groove 247 that receives the annular end of metallic screen 220. By appropriately sizing the grooves, the respective center support 218 and metallic screen 220 can be press-fit attached to the end cap 242. Alternatively, the end cap could be overmolded around both of the center support 218 and screen 220. As shown in FIG. 1, center support 218 includes internal threads 22 that allow for attachment to the filter head 14.

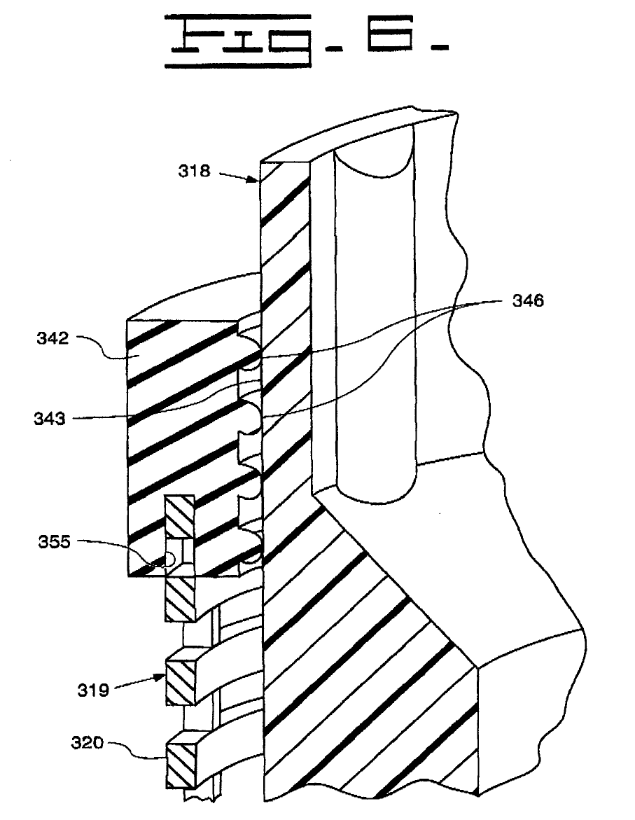

Referring now to FIG. 6, still another embodiment of the present invention includes an end cap 342, which could be made from any suitable elastomer, that includes a plurality of sealing protrusions 346 that engage the outer surface 343 of center support 318. Like a couple of the previous embodiments, end cap 342 is over molded to include a groove 355 that allows for attachment to one end of metallic screen 320. In this embodiment, the filter element assembly 319 is slid onto the outer surface of center support 318, and thus may be later separated to help facilitate cleaning.

### Industrial Applicability

The present invention allows an engine buyer to choose between a fuel filter assembly with a replaceable paper filter element or a cleanable metallic screen filter element according to the present invention. In addition, and users of the engine can, during the life of the engine, substitute a washable screen filter element assembly 19 according to the present invention for a used paper filter element 74 at time of servicing. For instance, at time of servicing, an engine having a paper filter element that is in need of replacement could either have another paper filter element installed or have a washable filter element according to the present invention installed. If the engine already has a metallic screen filter element according to the present invention, the filter element can be washed in a conventional manner and then reinstalled for filtering until the next scheduled maintenance.

In the preferred embodiment, the filter assembly 12 is assembled by first securing a screen filter element 20 to a center support 18 in a conventional manner, such as one of the ways illustrated before. Preferably, the screen filter element 20 comes preassembled as a filter element assembly 19 with the center support 18 permanently attached thereto. The filter element assembly 19 is then advanced over the male locking stem 37 of the bowl and then twisted to its locked position as shown in FIG. 1. Next, the bowl and filter element subassembly is mated to the filter head 14 by inserting the threaded stud 26 into the open end of center support 18. Next, the subassembly is rotated with respect to filter head 14 so that the internal threads 22 engage the external threads 24. The subassembly is then rotated until the bowl 16 advances into the filter head sufficiently far so that the O-Ring 28 is sealingly engaged between the outer surface of bowl 16 and the inner surface of filter head 14 as shown in FIG. 1. When properly coupled, the bowl 16 cannot be actually removed due to the presence of the stopping mechanism that engages the keyed male locking member 36. This same feature also allows for the subassembly of the bowl 16 and filter element assembly 119 to be threadably attached to the filter head.

The present invention is advantageous in that it gives an engine buyer or user a choice between a replaceable filter element or a cleanable and reusable filter element. The washable metallic screen filter element of the present invention can be preferred in some applications, such as use in remote locations where replacement filters are not available and/or fuel quality is relatively poor in that it may include an excessive amount of contaminants. In such situations, the filter element can be quickly disengaged from the filter head washed and replaced even when a heavily contaminated fuel source is used. In addition, the filter element can be quickly cleaned and reused over the life of an engine to save on cost and promote maintaining a clean fuel supply to the engine.

It should be further understood that the above description is intended for illustrative purposes only, and is not intended to limit the scope of the present invention in any way. Thus, those skilled in the art will appreciate that other aspects, objects, and advantages of the invention can be obtained from a study of the drawings, the disclosure and the appended claims.

1. A filter assembly comprising:
a center support having a filter head attachment adjacent one end, a bowl attachment adjacent an opposite end, and a plurality of radial openings disposed in said center support and being located between said ends; and
a metallic screen filter element mounted around said center support.

2. The filter assembly of claim 1 including a bowl attached to said bowl attachment.

3. The filter assembly of claim 2 including a filter head attached to said filter head attachment; and
an annular seal between said bowl and said filter head.

4. The filter assembly of claim 3 wherein said center support includes a plastic center tube.

5. The filter assembly of claim 4 including a first end cap in contact with said metallic screen and said center support adjacent said one end; and
a second end cap in contact with said metallic screen and said center support adjacent said opposite end.

6. The filter assembly of claim 5 wherein said first and second end caps are removably attached to said center support.

7. The filter assembly of claim 1 including a hydrophobic coating on said metallic screen filter element.

8. The filter assembly of claim 3 wherein said center support is permanently affixed to said metallic screen filter element;
whereby said center support is necessary for connecting said bowl in sealing contact with said filter head.

9. A plurality of engines comprising:
a portion of said engines including a filter assembly according to claim 1; and
another portion of said engines including a filter assembly according to claim 1, except with a paper filter element substituted in place of the metallic screen filter element.

10. The engines of claim 9 wherein said filter assembly of each engine includes an identical center support.

11. The engines of claim 10 wherein said identical center support includes a center tube.

12. A method of servicing a filtration portion of a fluid system for an engine, comprising the steps of:
detaching a center support from a filter head;
detaching the center support from a bowl;
washing a metallic screen filter element which is attached to the center support;
re-attaching the center support to the bowl; and
re-attaching the center support to the filter head.

13. The method of claim 12 wherein said washing step includes the steps of:
detaching the metallic screen filter element from the center support;
cleaning the metallic screen filter element; and
re-attaching the metallic screen filter element to a center support.

14. A method of servicing a filtration portion of a fluid system for an engine, comprising the steps of:
detaching a center support from a filter head;
detaching the center support, which is attached to one of a paper filter element and a metallic screen filter element, from a bowl;
attaching a replacement center support, which is attached to an other of a paper filter element and a metallic screen filter element, to the bowl; and
attaching the replacement center support to the filter head.
